(19) United States
(12) Patent Application Publication
(10) Pub. No.: US 2014/0315079 A1
(43) Pub. Date: Oct. 23, 2014

(54) METHOD FOR PREPARING PENTACYCLIC ANION SALT

(71) Applicant: ARKEMA FRANCE, Colombes Cedex (FR)

(72) Inventors: Gregory Schmidt, Colombes (FR); Miguel Flasque, Amiens (FR)

(21) Appl. No.: 14/357,784

(22) PCT Filed: Oct. 29, 2012
(86) PCT No.: PCT/FR2012/052489

§ 371 Date: May 13, 2014

(30) Foreign Application Priority Data
Nov. 14, 2011 (FR) 11 60301

(51) Int. Cl. H01M 10/0568

(52) U.S. Cl. CPC H01M 10/0568
USPC 429/188; 548/324.5; 548/109; 548/337.1

(57) ABSTRACT

A method for preparing an imidazole compound with the following formula: wherein Rf is a fluorinated alkyl group comprising between 1 and 5 carbon atoms, said method including: (a) the reaction of the diaminomaleonitrile with the following formula: with the compound with the following formula: wherein Y represents a chlorine atom or the OCORf group to form the salified amide compound with the following formula: at temperature T₁, and (b) the dehydration of the salified amide compound with formula (IVa) and/or the corresponding amino (IVb) to form the imidazole compound with formula (III), at temperature T₂ higher than T₁.

### FIELD OF THE INVENTION

The present invention relates to a process for preparing a pentacyclic anion salt, and especially lithium 1-trifluoromethyl-4,5-dicarbonitrile-imidazolate, and also to a process for preparing electrolyte compositions containing such a salt.

### TECHNICAL BACKGROUND

A lithium-ion battery comprises at least a negative electrode, a positive electrode, a separator and an electrolyte. The electrolyte consists of a lithium salt dissolved in a solvent, which is generally a mixture of organic carbonates, so as to have a good compromise between the viscosity and the dielectric constant.

Among the salts most commonly used is lithium hexafluorophosphate (LiPF6), which has many of the numerous qualities required, but has the drawback of degrading in the form of hydrogen fluoride gas. This poses safety problems, especially in the context of the coming use of lithium-ion batteries for private vehicles.

Other salts have thus been developed to provide Li-ion battery electrolytes, and especially LiTDI (lithium 1-trifluoromethyl-4,5-dicarbonitrile-imidazolate) and LiPDI (lithium 1-pentafluoroethyl-4,5-dicarbonitrile-imidazolate), as is taught in document WO 2010/023 413. These salts have the advantage of containing fewer fluorine atoms and of comprising strong carbon-fluorine bonds in place of the weaker phosphorus-fluorine bonds of LiPF6. In addition, these salts have very good conductivities, of the order of 6 mS/cm, and very good dissociation between the imidazolate anion and the lithium cation.

Document WO 2010/023 413 proposes several synthetic routes for manufacturing these pentacyclic anions, one of which consists in condensing diaminomaleonitrile (DAMN) with an acid derivative such as a fluorinated acid anhydride, followed by a proton/lithium exchange. The condensation is performed in a single step.

The maximum yield of lithium salt obtained with the known synthetic routes is about 70%. The impurities present necessitate heavy downstream purification steps, which represents a curb on a possible industrialization of this type of lithium salt for use as an electrolyte salt for Li-ion batteries.

Consequently, there is a real need to develop a process for obtaining lithium salts such as LiTDI or LiPDI in a better yield.

### SUMMARY OF THE INVENTION

The invention relates firstly to a process for preparing an imidazole compound of formula:

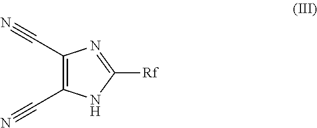

in which Rf is a fluoro alkyl or alkoxy group comprising from 1 to 5 carbon atoms, the process comprising:
(a) the reaction of diaminomaleonitrile of formula:

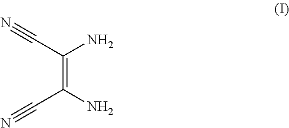

with the compound of formula:

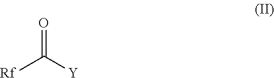

in which Y represents a chlorine atom or the group OCORf, to form the salified amide compound of formula (IVa) and/or the corresponding amine (IVb), at a temperature T₁.

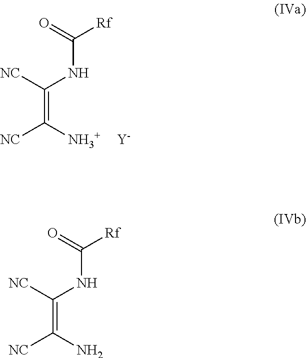

(b) dehydration of the salified amide compound of formula (IVa) and/or the corresponding amine of formula (IVb) to form the imidazole compound of formula (III), at a temperature T₂ above T₁.

According to one embodiment, Rf represents CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₆OCF₃, C₂F₄OCF₃, C₂H₂F₂OCF₃ or CF₂OCF₃, preferably CF₃, C₂F₅, C₂F₄OCF₃, C₂H₂F₂OCF₃ or CF₂OCF₃.

According to one embodiment, T₁ is from 0 to 80° C., preferably from 10 to 50° C., more preferentially from 20 to 30° C.

According to one embodiment, T₂ is from 30 to 180° C., preferably from 60 a 150° C., more preferentially from 75 to 140° C.

According to one embodiment, step (a) lasts from 1 to 12 hours, preferably from 1 to 3 hours, and/or step (b) lasts from 1 to 12 hours, preferably from 1 to 3 hours.

According to one embodiment, diaminomaleonitrile and the compound of formula (II) are dissolved in a solvent prior to step (a), the solvent preferably being 1,4-dioxane.

According to one embodiment, the temperature T₂ corresponds to the boiling point of the solvent.

The invention also relates to a process for preparing a lithium imidazolate compound of formula:

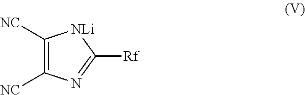

in which Rf is a fluoro alkyl or alkoxy group comprising from 1 to 5 carbon atoms, the process comprising:
(a) preparation of the imidazole compound of formula:

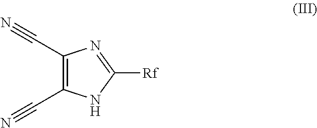

according to the process described above; and
(b) reaction of the imidazole compound of formula (III) with a lithium base.

According to one embodiment, the lithium base is chosen from lithium hydride, lithium carbonate and lithium hydroxide, and combinations thereof.

The invention also relates to a process for manufacturing an electrolyte composition, comprising the preparation of lithium imidazolate of formula (V) according to the process described above, and the dissolution of this compound in a solvent.

The invention also relates to a process for manufacturing a battery or a battery cell, comprising the manufacture of an electrolyte composition according to the process described above and the insertion of this electrolyte composition between an anode and a cathode.

The present invention makes it possible to overcome the drawbacks of the prior art. It more particularly provides a process for obtaining lithium salts such as LiTDI or LiPDI in a better yield.

This is accomplished by means of the development of a process for preparing fluorinated 4,5-dicarbonitrile-imidazole via the reaction of DAMN with a fluorinated acid derivative in two steps that are performed at different temperatures, the temperature of the second step being higher than the temperature of the first step.

Thus, a salified amide compound and/or corresponding amine which is a reaction intermediate (the compound of formulae (IVa) and (IVb)) is produced stably, in the first step, this salified amide compound and/or corresponding amine then being dehydrated to form the imidazole, during the second step.

Without wishing to be bound by a theory, it is estimated that the low imidazole production yield observed in the prior art is due to the polymerization of DAMN by heating, particularly in acidic medium.

Now, thermal analyses have made it possible to demonstrate that the salified amide compound and/or the corresponding amine intermediate is thermally more stable than DAMN. DAMN undergoes substantial degradation at and above 188° C., whereas the intermediate salified amide and/or the corresponding amine undergo(es) first a dehydration and then degradation at and above 210° C.

Given, firstly, the greater thermal stability of the intermediate salified amide compound and/or the corresponding amine relative to DAMN, and, secondly, the fact that the C═O function of the amide compound has a tendency to deactivate the C═C double bond and that, in the case of the salified amide, the salified amine is a poorer nucleophile; this thus makes it possible to disfavor the polymerization. The process according to the invention makes it possible: in a first stage, to form the intermediate salified amide compound and/or the corresponding amine stably, at a relatively low temperature at which the polymerization of DAMN is essentially avoided; and, in a second stage, to dehydrate the salified amide compound and/or the corresponding amine at a higher temperature, once again avoiding the polymerization of DAMN (this reagent having already been consumed) and similarly the polymerization of the amide compound (for the reasons presented above).

### DESCRIPTION OF EMBODIMENTS OF THE INVENTION

The invention is now described in greater detail and in a nonlimiting manner in the description that follows.

### Preparation of the Imidazole Compound

The invention provides for the preparation of the imidazole compound of formula (III) from DAMN of formula (I) and from a fluorinated acid derivative of formula (II), according to the following general scheme:

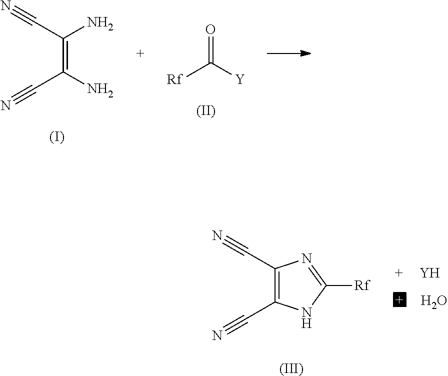

In this scheme, Rf is a fluoro alkyl or alkoxy group (i.e. an alkyl or alkoxy group comprising one or more fluorine substituents), comprising from 1 to 5 carbon atoms such as CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₆OCF₃, C₂F₄OCF₃, C₂H₂F₂OCF₃ or CF₂OCF₃, preferably CF₃, C₂F₅, C₂F₄OCF₃, C₂H₂F₂OCF₃ or CF₂OCF₃.

Moreover, Y represents a chlorine atom (in which case the compound of formula (II) is an acyl chloride) or the group OCORf (in which case the compound of formula (II) is an anhydride).

This reaction is performed in two steps.

The first step is performed at a temperature T₁ which is from 0 to 80° C., preferably from 10 to 50° C. and more preferentially from 20-30° C., for example about 25° C. This first step makes it possible to produce the salified amide compound of formula (IVa) and/or the corresponding amine of formula (IVb):

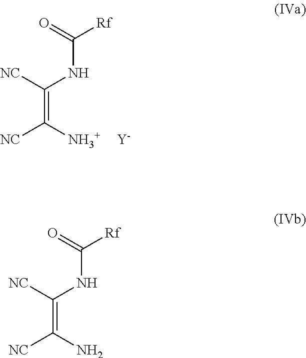

The duration of this first step is preferably from 1 to 12 hours, more particularly from 1 to 3 hours, for example about 2 hours.

The reaction is preferably performed by dissolving the reagents in a solvent, for example dioxane, toluene or dimethylformamide, and especially 1,4-dioxane. Advantageously, the two steps are performed in the same solvent.

The DAMN concentration in the reaction medium is preferably from 0.001 to 2 mol/L and more preferentially from 0.1 mol/L to 1 mol/L. The mole ratio of compound (I) to compound (II) is preferably from 0.25 to 1.5 and more preferentially from 0.5 to 1.25.

The second step is performed at a temperature T₂ which is higher than T₁. Preferably, T₂ is higher than T₁ by at least 10° C., or at least 20° C., or at least 30° C., or at least 40° C., or at least 50° C., or at least 60° C., or at least 70° C.

According to a particular embodiment, the temperature T₂ corresponds to the boiling point of the solvent used.

Preferably, T₂ is from 30 to 180° C., more particularly from 60 to 150° C., more preferentially from 75 to 140° C., for example about 100 or 101° C. (which corresponds to the boiling point of 1,4-dioxane).

The concentration of compound (IVa) and/or (IVb) in the reaction medium during the second step is preferably from 0.001 to 2 mol/L and more preferentially from 0.05 mol/L to 0.75 mol/L.

Preferably, the second step is performed immediately after the first step without intermediate purification and advantageously without any separation step, simply by modifying the temperature of the reaction mixture, by heating.

In the case where Y═Cl, the amide is salified by adding a carboxylic acid, which also makes it possible to improve the yield for the second step by acidic catalysis. The acids used are, for example, trifluoroacetic acid, acetic acid or benzoic acid, and preferably trifluoroacetic acid.

The mole ratio of compound (IVa) and/or (IVb) to the catalyst is preferably from 0.5 to 20 and more preferentially from 1 to 10.

The reaction temperature T₁ may be constant throughout the first step, and the reaction temperature T₂ may be constant throughout the second step, but this is not necessarily the case. It is possible, for example, to envisage an increasing temperature throughout the reaction, or throughout the first step only. In such cases, the condition according to which T₂ is higher than T₁ means that the temperature throughout the second step is higher than the temperature throughout the first step, that is to say again that the minimum temperature reached during the second step is higher than the maximum temperature reached during the first step.

A transition period is necessary to pass from the first step to the second step and to perform the required temperature change. This transition period preferably has a duration of less than 1 hour, for example less than 30 minutes, for example less than 20 minutes, for example less than 10 minutes, for example less than 5 minutes.

After this reaction, the imidazole compound of formula (III) is preferably isolated and purified, for example by evaporating off the solvent, adding water, extracting the aqueous phase obtained (for example with ethyl acetate) and recovering the organic phases.

### Preparation of the Lithium Imidazolate

The lithium imidazolate of formula:

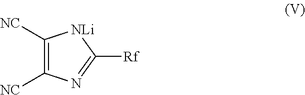

is prepared from the imidazole compound of formula (III), by reacting it with a lithium base, preferably chosen from lithium hydride, lithium carbonate and lithium hydroxide, and combinations thereof.

For example, when the imidazole compound has been isolated and purified as described above after the reaction, it is possible to extract the organic phases obtained with an aqueous solution of the lithium base. The aqueous phase can then be evaporated (after an optional treatment with active charcoal).

The organic phase thus contains compound (III) and also the residue YH and the acidic catalyst dissolved in the reaction solvent. Compound (III) is then at a concentration that is preferably from 0.01 to 5 mol/L and preferentially from 0.1 to 3 mol/L. The concentration of lithium base in the aqueous phase is preferably from 0.01 to 10 mol/L and more preferentially from 0.1 to 5 mol/L.

The lithium salt obtained is, for example, LiTDI when Rf represents a trifluoromethyl group, and LiPDI when Rf represents a pentafluoroethyl group.

### Preparation of an Electrolyte

The compounds of formula (V) prepared as described above, and especially LiTDI and LiPDI, may be used for the preparation of an electrolyte, by dissolving them in a suitable solvent.

The compounds of formula (V) are, for example, dissolved in a mixture composed of 1 to 5 constituents chosen from the following carbonates: ethylene carbonate, dimethyl carbonate, ethyl methyl carbonate, diethyl carbonate, propylene carbonate; and from the following glymes: ethylene glycol dimethyl ether, diethylene glycol dimethyl ether, dipropylene glycol dimethyl ether, diethylene glycol diethyl ether, triethylene glycol dimethyl ether, diethylene glycol dibutyl ether, tetraethylene glycol dimethyl ether and diethylene glycol t-butyl methyl ether. The mass proportions of each of the constituents are preferably between 1 and 10 relative to the constituent that is present in smallest amount, more preferentially between 1 and 8.

The concentration of compound of formula (V) in the electrolyte is preferably from 0.1 mol/L to 5 mol/L and more preferentially from 0.2 mol/L to 2.5 mol/L.

This electrolyte may then be used for the manufacture of batteries or battery cells, by placing it between a cathode and an anode, in a manner that is known per se.

### EXAMPLE

The example that follows illustrates the invention without limiting it.

### Synthesis of LiTDl

1.25 g of diaminomaleonitrile are dissolved in 45 mL of 1,4-dioxane in a 200 mL round-bottomed flask. Trifluoroacetic anhydride (1.6 mL) is then added to this solution. The reaction medium is stirred at 25° C. for 2 hours, which corresponds to the first step of the above reaction scheme. The reaction medium is then heated at the reflux point of dioxane for 2 hours to allow dehydration of the amide compound formed during the first step, which is catalyzed with the residual trifluoroacetic acid obtained during the first step.

The reaction medium is then evaporated. Water (60 mL) is then added and the aqueous phase obtained is extracted with 2×50 mL of ethyl acetate. The organic phases are then combined and extracted with aqueous lithium carbonate solution (0.5 g of Li₂CO₃ in 60 mL of water).

Since the aqueous phase obtained is colored, it is decolorized by treatment with active charcoal. After treatment, this aqueous phase is evaporated and gives 2.01 g of lithium salt, which corresponds to a yield of 90.5%.

1. A process for preparing an imidazole compound of formula: 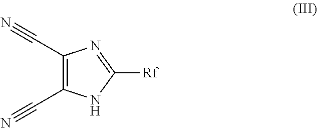
in which Rf is a fluoro alkyl or alkoxy group comprising from 1 to 5 carbon atoms, the process comprising:
(a) the reaction of diaminomaleonitrile of formula: 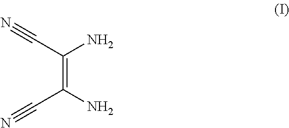
with the compound of formula: 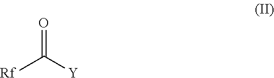
in which Y represents a chlorine atom or the group OCORf, in the presence of a solvent, to form the salified amide compound of formula (IVa) and/or the corresponding amine of formula (IVb): 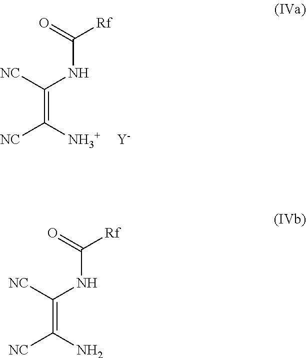
at a temperature T₁, and
(b) dehydration of the salified amide compound of formula (IVa) and/or the corresponding amine (IVb) to form the imidazole compound of formula (III), at a temperature T₂ above T₁.

2. The process as claimed in claim 1, in which Rf represents CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₆OCF₃, C₂F₄OCF₃, C₂H₂F₂OCF₃ or CF₂OCF₃.

3. The process as claimed in claim 1, in which T₁ is from 0 to 80° C.

4. The process as claimed in claim 1, in which T₂ is from 30 to 180° C.

5. The process as claimed in claim 1, in which step (a) lasts from 1 to 12 hours.

6. The process as claimed in claim 1, in which steps (a) and (b) are performed in the same solvent.

7. The process as claimed in claim 1, in which diaminomaleonitrile and the compound of formula (II) are dissolved in a solvent prior to step (a).

8. The process as claimed in claim 1, in which the temperature T₂ corresponds to the boiling point of the solvent.

9. The process as claimed in claim 1, in which the second step is performed immediately after the first step.

10. The process as claimed in claim 1, wherein the product formed in step (a) is the compound of formula (IVa).

11. The process as claimed in claim 1, wherein the product formed in step (a) is the compound of formula (IVb).

12. A process for preparing a lithium imidazolate compound of formula: 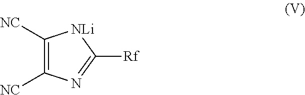
in which Rf is a fluoro alkyl group comprising from 1 to 5 carbon atoms, the process comprising:
(a) preparation of the imidazole compound of formula: 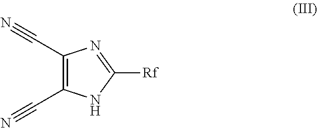
according to the process of claim 1; and
(b) reaction of the imidazole compound of formula (Ill) with a lithium base.

13. The process as claimed in claim 12, in which the lithium base is chosen from lithium hydride, lithium carbonate and lithium hydroxide, and combinations thereof.

14. A process for manufacturing an electrolyte composition, comprising the preparation of the lithium imidazolate of formula (V) according to the process of claim 12, and dissolution of this compound in a solvent.

15. A process for manufacturing a battery or a battery cell, comprising the manufacture of an electrolyte composition according to the process of claim 14 and the insertion of this electrolyte composition between an anode and a cathode.
